(19) United States
(12) Patent Application Publication
(10) Pub. No.: US 2011/0158310 A1
(43) Pub. Date: Jun. 30, 2011

(54) DECODING DATA USING LOOKUP TABLES

(75) Inventor: Parthasarathy Sriram, Los Altos, CA (US)

(73) Assignee: NVIDIA CORPORATION, Santa Clara, CA (US)

(21) Appl. No.: 12/650,309

(22) Filed: Dec. 30, 2009

(51) Int. Cl. H04N 11/02

(52) U.S. Cl. 375/240.01; 375/E07.026

(57) ABSTRACT

To decode encoded data, an element in a first lookup table is indexed using an index determined from a sequence of bits in a data stream. The element has either a first format or a second format. The first format includes a run field, a level field, and a length field. The second format includes an offset field. If the element is in the first format, then information in the run, level, and length fields is used to retrieve a decoded symbol corresponding to the sequence of bits. If the element is in the second format, then information in the offset field is used to locate a second lookup table that is used in a manner similar to that of the first lookup table to advance the decoding process.

### BACKGROUND

There are many different audio and video compression formats, such as but not limited to Windows Media Audio (WMA), Advanced Audio Coding (AAC), MP3, MPEG-2, and MPEG-4. In general, these formats use Huffman coding.

Efficient variable length extraction of bit fields is critical for high-performance and ultra-low-power decoding of compressed audio and video content. Existing implementations use techniques that may be memory efficient at the cost of performance, or vice versa. Performance improvements are usually achieved by using large lookup tables that consume lots of memory.

For example, a Huffman-like compression format that relies on a two-bit lookup per stage may be highly inefficient as every decode has to go through multiple lookups to decode a symbol. The most frequent Huffman table used in such a compression format may have, for example, a worst-case codeword length of 21 bits. Consequently, a worst-case element goes through 11 lookups before the element can be resolved. In general, the average codeword length (ACL) for such a compression format would be around eight (8) bits. Thus, on average, the decode process needs to do between four (4) and five (5) two-bit lookups before an average field can be resolved, which is not very efficient. Furthermore, the tables are structured for the worst case, so that even frequently occurring elements have to go through a decision process, making the lookup process inherently inefficient.

Also, after a Huffman index is resolved, conventional implementations perform another lookup to get the actual information associated with the index. The additional lookup table is relatively large, because it has to resolve all the indices for which there are valid Huffman codes. The table packs 4 bytes per element, as it has to encode all the worst possible run-length-last scenarios. This essentially doubles the table size requirement, without a commensurate improvement in performance. The additional lookup also increases by one the average number of lookups per codeword (ALPC). Thus, in the above example, ALPC is increased to between 5 and six (6).

### SUMMARY

According to embodiments of the present invention, a sequence of bits in a data stream is accessed and used as an index to find an element in a primary lookup table. Not all of the bits in the sequence may be needed to find the element. If a designated leaf bit in that element is one, then the element is a terminating (leaf) element, and the set of bits used to index that element is resolved. Specifically, the combination of run, level, and length information included in the element is mapped to a decoded symbol. If, on the other hand, the designated leaf bit in the indexed element is zero, then the element is a non-terminating (non-leaf) element, and the information included in that element is used to locate a next (e.g., secondary) table that is accessed to advance the decoding process. Additional bits are accessed from the data stream and used to index an element in the secondary table. In a manner similar to that just described, the designated leaf bit of the indexed element in the secondary table is used to determine whether the element is a terminating element or a non-terminating element. If the element is a terminating element, then the combination of run, level, and length information included in the element is mapped to a decoded symbol; otherwise, the information in the element is used to locate a next (e.g., tertiary) table, and the process just described is repeated until it leads to a terminating element that can be mapped to a decoded symbol.

In general, embodiments according to the invention use different types of formats for lookup table elements, depending on whether the element is a terminating element or a non-terminating element, and depending on whether the lookup is the primary lookup or a secondary (or tertiary, etc.) lookup. The lengths of the table indexes and the table elements are chosen to minimize, or at least reduce, ALPC, which significantly improves performance. As well, the combination of information (e.g., run, level, etc.) packed into the table elements, as well as the lengths of the fields used to pack that information, are chosen such that ALPC is reduced/minimized to a range of 1-2. Furthermore, by using the table hierarchy in combination with the element formats just described, memory requirements are reduced. According to embodiments of the invention, four times less memory is used relative to conventional implementations. As such, the tables can be implemented in internal random access memory, which reduces power consumption to meet ultra-low power audio decode power targets.

These and other objects and advantages of the various embodiments of the present invention will be recognized by those of ordinary skill in the art after reading the following detailed description of the embodiments that are illustrated in the various drawing figures.

### BRIEF DESCRIPTION OF THE DRAWINGS

The accompanying drawings, which are incorporated in and form a part of this specification, illustrate embodiments of the present invention and, together with the description, serve to explain the principles of the invention.

FIG. 1 is a block diagram of a system upon which embodiments according to the invention can be implemented.

FIG. 2 is a block diagram illustrating a hierarchy of lookup tables according to an embodiment of the invention.

FIG. 3 illustrates an example of a lookup table according to an embodiment of the invention.

FIG. 4 illustrates examples of formats of elements in lookup tables according to an embodiment of the invention.

FIG. 5 is a flowchart of a computer-implemented method for decoding data according to an embodiment of the invention.

### DETAILED DESCRIPTION OF THE INVENTION

Reference will now be made in detail to the various embodiments of the present invention, examples of which are illustrated in the accompanying drawings. While the invention will be described in conjunction with these embodiments, it will be understood that they are not intended to limit the invention to these embodiments. On the contrary, the invention is intended to cover alternatives, modifications and equivalents, which may be included within the spirit and scope of the invention as defined by the appended claims. Furthermore, in the following detailed description of the present invention, numerous specific details are set forth in order to provide a thorough understanding of the present invention. However, it will be understood that the present invention may be practiced without these specific details. In other instances, well-known methods, procedures, components, and circuits have not been described in detail so as not to unnecessarily obscure aspects of the present invention.

Some portions of the detailed descriptions that follow are presented in terms of procedures, logic blocks, processing, and other symbolic representations of operations on data bits within a computer memory. These descriptions and representations are the means used by those skilled in the data processing arts to most effectively convey the substance of their work to others skilled in the art. In the present application, a procedure, logic block, process, or the like, is conceived to be a self-consistent sequence of steps or instructions leading to a desired result. The steps are those utilizing physical manipulations of physical quantities. Usually, although not necessarily, these quantities take the form of electrical or magnetic signals capable of being stored, transferred, combined, compared, and otherwise manipulated in a computer system. It has proven convenient at times, principally for reasons of common usage, to refer to these signals as transactions, bits, values, elements, symbols, characters, samples, pixels, or the like.

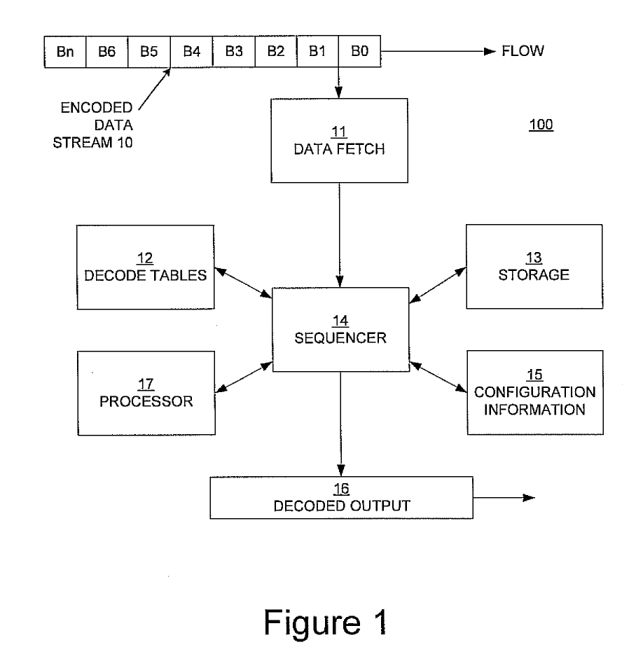

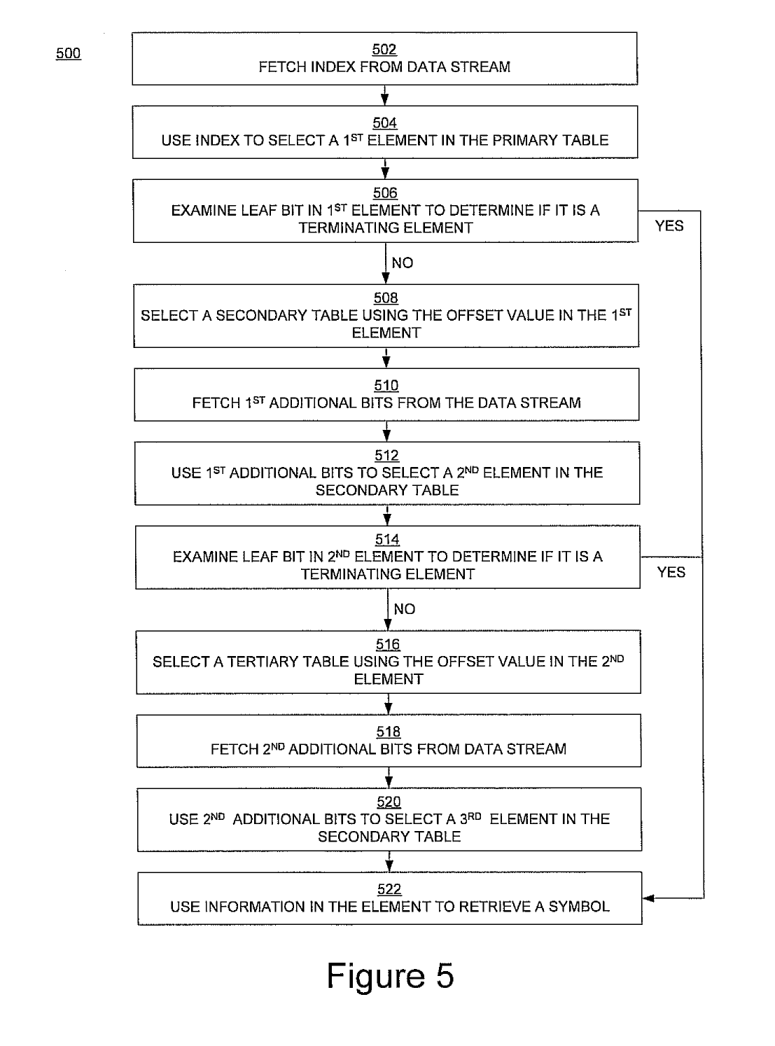

It should be borne in mind, however, that all of these and similar terms are to be associated with the appropriate physical quantities and are merely convenient labels applied to these quantities. Unless specifically stated otherwise as apparent from the following discussions, it is appreciated that throughout the present invention, discussions utilizing terms such as “indexing,” “retrieving,” “encoding,” “decoding,” “fetching,” “accessing,” “determining,” “examining,” or the like, refer to actions and processes (e.g., flowchart 500 of FIG. 5) of a computer system or similar electronic computing device or processor (e.g., system 100 of FIG. 1). The computer system or similar electronic computing device manipulates and transforms data represented as physical (electronic) quantities within the computer system memories, registers or other such information storage, transmission or display devices.

Embodiments described herein may be discussed in the general context of computer-executable instructions residing on some form of computer-usable medium, such as program modules, executed by one or more computers or other devices. By way of example, and not limitation, computer-usable media may comprise computer storage media and communication media. Generally, program modules include routines, programs, objects, components, data structures, etc., that perform particular tasks or implement particular abstract data types. The functionality of the program modules may be combined or distributed as desired in various embodiments.

Computer storage media includes volatile and nonvolatile, removable and non-removable media implemented in any method or technology for storage of information such as computer-readable instructions, data structures, program modules or other data. Computer storage media includes, but is not limited to, random access memory (RAM), read only memory (ROM), electrically erasable programmable ROM (EEPROM), flash memory or other memory technology, compact disk ROM (CD-ROM), digital versatile disks (DVDs) or other optical storage, magnetic cassettes, magnetic tape, magnetic disk storage or other magnetic storage devices, or any other medium that can be used to store the desired information and that can accessed to retrieve that information.

Communication media can embody computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, radio frequency (RF), infrared and other wireless media.

Compressed data streams such as WMA, AAC, MP3, MPEG-2, and MPEG-4 may be used in many applications including wireless data and voice transmission, audio and video recording and transmission, satellite communications, and so on. Encoded data streams can include variable length codewords and sign information, and each codeword can encode one or more symbols. Data streams may be processed in which sign information follows encoded symbols in an encoded data stream.

Referring to FIG. 1, in one embodiment, a decoding system 100 is implemented as an accelerator that receives portions of an encoded data stream and provides decoded data to signal processors, multimedia players, and recording devices. An accelerator can be constructed using combinations of processors and customized components according to system requirements and types of encoding schemes found in the data streams. In some embodiments, plural accelerating hardware subsystems can be controlled by one or more processors 17 for managing configuration information 15, providing decode tables 12, error handling, processing load management, etc. In certain embodiments, systems employ microprocessors and digital signal processors that can execute software algorithms used in the decoding of data streams. In other embodiments, hardware components such as configurable sequencers 14 may perform decoding functions without direct intervention by the processor 17. In certain embodiments, portions of the accelerators can be committed to hardware. Hardware includes storage 13 and memory that stores one or more decode tables 12, and fetchers 11 for extracting data from the encoded data stream 10 and for providing the data to other decoder elements and sequencers 14. The sequencer 14 can repeatedly receive portions of the encoded data stream 10 and decode codewords contained therein using decode tables 12 to produce decoded output data 16.

In one example, an accelerator includes a micro-programmed sequencer 14 that executes a series of decoding steps. The sequencer 14 can generate fetch requests to receive encoded data from the encoded data stream 10, and can use fetched data to look up elements in decode tables 12. The sequencer 14 can be adapted to extract bit fields from the looked-up elements and to interpret information in the bit fields through combinations of bit testing, bit field comparisons, additional fetches, and additional table lookups. The sequencer 14 can return decoded data 16 including available sign information. The sequencer 14 can also manage a bit stream pointer that indicates a current position in the data stream from which data may be fetched.

The sequencer 14 can be implemented on one or more device. In some embodiments, the sequencer 14 is programmable and can be configured to handle a plurality of data encoding schemes. In certain embodiments, configuration information 15 is provided by the processor 17 based on the data stream received. In some embodiments, the sequencer 14 can detect data stream format and select a configuration suitable to decode the data stream. In certain embodiments, decode tables can be provided and updated based on characteristics of the encoded data stream 10. In some embodiments, the processor 17 can be eliminated and the sequencer 14 can include logic and devices to identify or load decode tables and a sequencing algorithm appropriate for the detected data stream 10.

Efficient utilization of storage can be obtained by providing a hierarchy of decode tables 12 such that symbols having higher probabilities of occurrence are decoded in the higher levels of the hierarchy, so that higher probability symbols require fewer table lookups. In one embodiment, elements retrieved from the decode tables 12 are classified as either terminating elements or non-terminating elements. Terminating elements, also referred to as non-leaf elements or resolved elements, indicate that decoding of a codeword is completed/resolved. Non-terminating elements, also referred to as leaf elements or unresolved elements, indicate that additional table lookups are required. For example, in one embodiment, a particular field or flag in an element that is retrieved from the decode tables 12 can indicate whether the element is terminating or is non-terminating. In general, a terminating element includes information that maps or resolves to a decoded symbol, while a non-terminating element provides information such as an offset value that identifies the location of a table in the next level of the hierarchy of decode tables 12. Sign information can be retrieved from the data stream 10 after a terminating condition is encountered.

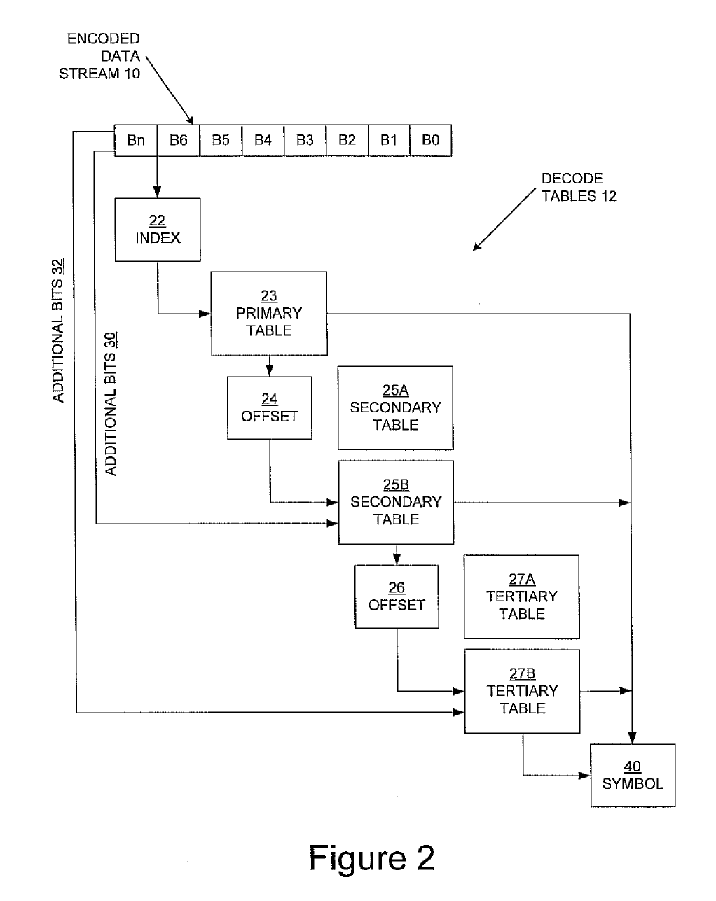

FIG. 2 illustrates an example of a hierarchy of decode tables 12 according to an embodiment of the invention. In the example, a plurality of Huffman-like tables are arranged in a hierarchical structure with a primary table 23, one or more secondary tables 25A and 25B, and one or more tertiary tables 27A and 27B. There may be more than two secondary tables, and more than two tertiary tables. Also, there may be more than three levels of tables in the hierarchy of decode tables; that is, there may be one or more levels of tables below the tertiary tables 27A and 27B.

A data stream 10 includes a sequence of bits B0, B1, . . . , Bn. A portion of the sequence—a set of contiguous bits—is fetched from the data stream 20 and used as an index 22 for indexing the primary table 23. In one embodiment, the index 22 consists of 8 bits. Not all of the bits in the index 22 may be needed to index (locate an entry in) the primary table 23. If, for example, 5 of the 8 bits can be mapped to an entry in the primary table 23, then the three (3) bits that are not used are included in the next sequence of 8 bits that are used as the next index—that is, the 3 bits that are not needed in the first index are combined with the next 5 bits in the data stream 10 to form the next index of 8 bits. If not all 8 bits are needed in the next lookup, then the unused bits from that lookup are used as part of the next lookup, and so on.

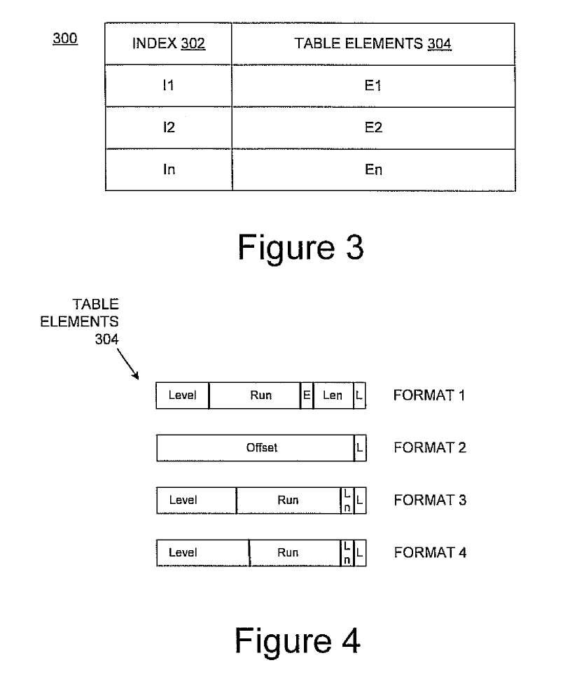

In general, the primary table 23 includes a number of indexed entries or elements (see FIG. 3, for example). The primary table 23 can include both terminating elements and non-terminating elements. In one embodiment, in the primary table 23, terminating elements are stored in a format referred to as Format 1, and non-terminating elements are stored in a format referred to as Format 2. Formats 1 and 2 are described further in conjunction with FIG. 4.

As noted above, a terminating element includes information that maps or resolves to a decoded symbol, while a non-terminating element provides information such as an offset value that identifies the location of a table in the next level of the hierarchy of decode tables. Location may be identified as a start address relative to the start or end of the primary table 23 or relative to the non-terminating element that contained the offset value. Location may also be identified using other means known in the art and can, for example, be identified using an index or an absolute address that is referenced by the offset value.

Continuing with reference to FIG. 2, the index 22 is used to select an element or entry in the primary table 23. If the index 22 indexes a terminating element in the primary table 23, then the information in that element can be resolved to a respective decoded symbol 40. If the index 22 indexes a non-terminating element in the primary table 23, then the information in that element (specifically, offset 24) can be used to identify/locate a particular one of the secondary tables. Also, if the index 22 indexes a non-terminating element in the primary table 23, then a first set of additional bits 30 is fetched from the data stream 10; the first set of additional bits 30 is used to index an element or entry in the particular secondary table.

In the example of FIG. 2, the offset value 24 is used to locate an entry in the secondary table 25B, and the first set of additional bits 30 is used to index an entry in that table. Some secondary tables include both terminating elements and non-terminating elements; other secondary tables include only terminating elements. In one embodiment, in the secondary tables (as well as in the tables below the secondary tables), terminating elements are stored in a format referred to as Format 3 or in a format referred to as Format 4, and non-terminating elements are stored in the format referred to above as Format 2. Format 1 can also be used in the secondary and lower tables. Formats 3 and 4 are described further in conjunction with FIG. 4.

If the first set of additional bits 30 indexes a terminating element in the secondary table 25B, then the information in that element can be resolved to a respective decoded symbol 40. If the first set of additional bits 30 indexes a non-terminating element in the secondary table 25B, then the information in that element (specifically, offset 26) can be used to identify/locate one of the tertiary tables (e.g., tertiary table 27B). Also, if the first set of additional bits 30 indexes a non-terminating element in the secondary table 25B, then a second set of additional bits 32 are fetched from the data stream 10 and used to index an element or entry in the selected tertiary table.

Some tertiary tables include both terminating elements (Format 1, Format 3 or Format 4) and non-terminating elements (Format 2); other tertiary tables include only terminating elements (Format 1, Format 3 or Format 4). In general, to decode a codeword or symbol, a process such as that just described advances from the primary table through the hierarchy of decode tables until a terminating element is reached, allowing the fetched sequence of bits to be decoded and resolved.

In one embodiment, a constant number of bits are fetched from the data stream 10 to form the set of additional bits 30, the set of additional bits 32, and any other set of additional bits used to index tables below the tertiary tables. In one such embodiment, the constant number of bits is two (2). Thus, the number of bits used to index lower level tables (that is, those tables other than the primary table 23) is known in advance, and so it is not necessary to store that value. Also, because 2 bits are used, each of the lower level tables includes only 4 elements or entries.

The hierarchical table structure in the example of FIG. 2 reflects a probabilistic assignment of codewords to symbols. Symbols can be organized according to calculated frequencies of occurrence of symbols. Frequencies of occurrence can be determined using any method including methods that use some combination of empirical, arbitrary, and calculated schemes.

More specifically, codewords identifying the highest probability symbols can be decoded using the highest level table (e.g., the primary table 23). The secondary tables 25 can be used to decode lower probability symbols (measured relative to those decoded using the primary table), and the tertiary tables 27 (and other tables lower in the hierarchy) can be used to decode even lower probability symbols. Thus, higher probability symbols can be decoded using fewer lookups than lower probability symbols. According to embodiments of the invention, the average length codeword can be resolved in a single lookup.

FIG. 3 illustrates an example of a lookup table 300 according to embodiments of the invention. The lookup table 300 is representative of the primary, secondary, tertiary, and any lower level tables in the hierarchy of tables described in conjunction with FIG. 2. Each lookup table 300 includes a listing of indexes 302 (e.g., I1, I2, . . . , In) and a corresponding listing of table elements 304 (e.g., E1, E2, . . . , En).

In one embodiment, in the primary table 23 (FIG. 2), each of the indexes 302 is up to 8 bits in length, and each of the table elements 304 is up to 16 bits in length. By choosing an 8-bit length for the indexes, end-of-block EOB) markers are included in the primary table 23 because all EOB markers are less than or equal to 8 bits in length; thus, EOB markers can be resolved in the first lookup. As mentioned above and as described further below, the table elements 304 in the primary table 23 can be packed in Format 1 or in Format 2. In general, the lengths of the indexes 302 and the table elements 304 can be chosen to reduce and/or minimize the average number of lookups per codeword (ALPC). An approach such as that described in U.S. Pat. No. 7,605,725, “Optimization of Decoder Memory Usage for VLC Tables,” by Puri et al., can be used to select lengths for the indexes and table elements appropriate to the compression format. By utilizing an index 22 (FIG. 2) of 8 bits and indexes 302 of up to 8 bits each with a compression scheme that has an average codeword length (ACL) of around 8 bits, the average codeword can be resolved in a single lookup. This will yield an ALPO of between one (1) and 2.

In one embodiment, in the tables other than the primary table 23 (e.g., in the secondary tables 25A and 25B and the tertiary tables 27A and 27B), each of the indexes 302 is 2 bits in length, and each of the table elements 304 is up to 16 bits in length. As mentioned above and as described further below, the table elements 304 in the secondary, tertiary, etc., tables can be packed in Format 1, Format 2, Format 3, or Format 4.

FIG. 4 illustrates examples of formats of resolved (terminating) and unresolved (non-terminating) elements 304 in the decode tables 12 (FIG. 2). Formats 1, 3, and 4 are examples of formats of terminating elements, and Format 2 is an example of a format of a non-terminating element. As noted above, a non-terminating element includes offset information that can be used to locate a lower level table in the hierarchy of decode tables, while a terminating element contains information that can map to a particular decoded symbol.

With reference back to the example of FIG. 2, the primary table 23 includes Format 1 and Format 2 elements, while secondary tables 25, tertiary tables 27, and any lower level tables may include Format 2 and Format 3 elements, or Format 2 and Format 4 elements. Format 1 elements can also be used instead of Format 3 or Format 4 elements in the secondary and lower tables. The lowest level tables in the hierarchy of decode tables will include only Format 1, Format 3, or Format 4 elements.

In general, Format 1 is used for decoded symbols that are resolved in the first lookup (that is, in a single lookup). In Format 1, a table element 304 (FIG. 3) contains the following fields of information: level, run, EOB, length, and leaf. The value of the run field identifies the number of contiguous zero-valued bits that begin the sequence of bits in the corresponding index 302 (FIG. 3). The value of the level field represents the bit values that follow the zero-valued bits. For example, a string of bits represented as [0 0 a] would have a level of “a” and a run of 2. There is an index associated with each level/run combination; there is an entry in the primary table 23 (FIG. 2) for each possible combination of level and run.

In Format 1 of FIG. 4, the EOB field (E) is used to indicate whether the sequence of bits being decoded is an EOB marker. For example, a value of 1 can be used to indicate an EOB marker; a value of 0 is otherwise used.

In Format 1, the value of the length field (Len) identifies the number of bits in the index 22 (FIG. 2) that were used; that is, the length field identifies how many bits of the index 22 were required to decode the symbol. If, for example, 5 of the 8 bits in the index 22 are used to look up an entry in the primary table 23, then the length field would have a value 5. As discussed above, the 3 bits that are not used in this lookup are included in the next sequence of 8 bits that are used as the next index for the next primary table lookup.

In Format 1, the length field is packed in “length+1” format so that the value of zero (0) can be used. That is, there will not be a case in which the length is 0. To not waste a 1-bit field for such a case, a binary value of [0 0 0] is used to indicate a length of 1, [0 0 1] is used to indicate a length of 2, and so on.

In Format 1, the leaf field (L) is a flag used to indicate that the entry is a terminating element. For example, a value of 1 can be used to indicate that the entry is a terminating (non-leaf) element.

Format 1 can be used for secondary lookups as well as for decoded symbols that are resolved in the single lookup, by using a combination of run, level, length, EOB, and leaf fields that maintain a 16-bit table element.

In Format 2, a table element 304 (FIG. 3) contains the following fields: offset, and leaf. The offset can be stored in a differential form. That is, in one embodiment, at every lookup stage:

curr_ptr=curr_ptr+offset;

where “curr_ptr” denotes the location of the current table. Location can be identified in various ways, as previously discussed herein. In Format 2, a value of 0 is used in the leaf field to indicate that additional lookups are needed to advance decoding.

Thus, in Format 1, the leaf field has a value of 1 but, in Format 2, the leaf field has a value of 0. Thus, the format used for a particular element in the primary table 23 (FIG. 2) is readily identified by reading the least significant bit (the right-most bit) in that element.

Formats 3 and 4 are used for the elements resolved in secondary, tertiary, etc., lookups. In Format 3 and in Format 4, the data is packed into the following fields: level, run, length, and leaf, where those fields are defined as described above.

The primary difference between Formats 3 and 4 is in the sizes of the level and run fields. A Huffman-like compression scheme may utilize different tables to encode symbols—Format 3 represents a format that can be used with one of the Huffman tables, and Format 4 represents a format that can be used with another of the Huffman tables. Means known in the art and external to the decoding tables described herein can be used to identify which Huffman table was used during encoding. Although only Format 3 and Format 4 are described herein, embodiments described herein are not so limited—there can be additional formats, depending on how many different tables are used in the encoding scheme. The primary difference between Format 3 and Format 4 is a 1 bit selection per block—this can be extended to N additional formats for N different tables.

In Formats 3 and 4, in one embodiment, the length field (Ln) needs only 1 bit because, as mentioned above, all secondary lookups use only 2 bits. Therefore, only a single bit is needed to resolve a bit length of 1 or 2 (a bit length of 0 is not possible). Also, because the number of bits to be fetched for each of the secondary lookups is known in advance (all the secondary lookups use 2 bits at a time), it is not necessary to store that value.

Furthermore, Formats 3 and 4 do not include an EOB marker because all EOB markers are less than or equal to 8 bits in length. Thus, EOB markers are resolved in the first lookup, and EOB markers do not need to be flagged in the secondary, tertiary, etc. lookups.

In Formats 1, 2, 3, and 4, information is packed using, at most, 2 bytes (16 bits) per index (per element). By using the table hierarchy of FIG. 2 in combination with the table formats of FIG. 4, memory requirements are reduced. According to embodiments of the invention, 4 times less memory (2 KB per table) is used relative to conventional implementations. As such, the tables can be implemented in internal RAM, which reduces power consumption to meet ultra-low power audio decode power targets. Also, by reducing ALPC from 5-6 to 1-2, performance is significantly improved.

In general, in operation, a sequence of bits (index 22 of FIG. 2) in a data stream is accessed and used as an index to find an element in a first lookup table (e.g., primary table 23 of FIG. 2). Not all of the bits in the sequence may be needed to find the element. If the least significant bit of that entry is 1, then the element is a terminating (leaf) element (Format 1), and the set of bits used to index that element is resolved. Specifically, the combination of run, level, and length information included in the element is mapped to a decoded symbol. If, on the other hand, the least significant bit of the indexed element is 0, then the element is a non-terminating (non-leaf) element (Format 2), and the information included in that element is used to locate a next (e.g., secondary) table that is accessed to advance the decoding process. Two additional bits are accessed from the data stream and used to index an element in the secondary table. In a manner similar to that just described, the least significant bit of the element in the secondary table is used to determine whether the element is a terminating element (Format 3 or Format 4) or a non-terminating element (FIG. 2). If the element is a terminating element, then the combination of run, level, and length information included in the element is mapped to a decoded symbol; otherwise, the information in the element is used to locate a next (e.g., tertiary) table, and the process just described is repeated until it leads to a terminating element.

FIG. 5 is a flowchart 500 of an example of a computer-implemented method for decoding a data stream according to an embodiment of the invention. Flowchart 500 can be implemented as computer-executable instructions residing on some form of computer-usable medium.

In block 502, with reference also to FIG. 2, an index 22 is fetched from a data stream 10. In block 504, the index 22 is used to select an element in the primary table 23.

In block 506 of FIG. 5, the leaf bit (bit L in FIG. 4) can be examined to determine whether the element is a terminating element, in which case a decoded symbol 40 can be retrieved. If so, then the flowchart 500 proceeds to block 522; otherwise, the flowchart proceeds to block 508 to continue decoding.

In block 508 of FIG. 5, with reference also to FIG. 2, if the leaf bit L indicates that the element is a non-terminating element, in which case decoding is to continue, a selected one of the next level of tables (e.g., secondary tables 25A and 25B) is referenced using the offset value 24 obtained from the element indexed in the primary table 23 (the offset value shown in Format 2 of FIG. 4).

In block 510 of FIG. 5, with reference also to FIG. 2, additional bits 30 (e.g., 2 additional bits) are fetched from the data stream 10 and used as an index to select an entry in the selected secondary table 25A or 25B (block 512).

In block 514, the leaf bit (bit L of FIG. 4) is examined to determine whether a decoded symbol 40 can be retrieved. The entry in the selected secondary table may use Format 2, and it may instead use Format 3 or Format 4 depending on, for example, the Huffman table that was used to encode the portion of the data stream from which index 22 and the additional bits 30 are fetched.

If the leaf bit in the entry in the secondary table indicates that a symbol can be retrieved, then the flowchart 500 proceeds to block 522; otherwise, the flowchart proceeds to block 516 to continue decoding.

In block 516 of FIG. 5, with reference also to FIG. 2, if the leaf bit L indicates that decoding is to continue, a selected one of the next level of tables (e.g., tertiary tables 27A and 27B) is referenced using the offset value 26 obtained from the element indexed in the selected secondary table (the offset value shown in Format 2 of FIG. 4).

In block 518 of FIG. 5, with reference also to FIG. 2, additional bits 32 (e.g., 2 additional bits) are fetched from the data stream 10 and used as an index to select an entry in the selected tertiary table 27A or 27B (block 520).

As previously described herein, more than three levels of tables can be provided, so that the process described by flowchart 500 can be extended to include lower level tables. Ultimately, in block 522, a terminating element (Format 1, 3, or 4) is reached, and the combination of level, run, and length information included in that element can be used to retrieve a symbol 40 (FIG. 2).

In summary, embodiments according to the invention use different types of formats for lookup table elements, depending on whether the element is a terminating element or a non-terminating element, and depending on whether the lookup is the primary lookup or a secondary (or tertiary, etc.) lookup. The lengths of the table indexes and the table elements are chosen to minimize, or at least reduce, ALPC, significantly improving performance. As well, the chosen combination of information (e.g., run, level, etc.) packed into the table elements, as well as the lengths of the fields used to pack that information, reduces/minimizes ALPC. In addition, memory requirements and power consumption are reduced.

Embodiments according to the present invention are thus described. While the present invention has been described in particular embodiments, it should be appreciated that the present invention should not be construed as limited by such embodiments, but rather construed according to the below claims.

What is claimed is:

1. A computer-implemented method for decoding data, the method comprising:
indexing a first element in a first lookup table using an index determined from a sequence of bits in a data stream, the first element having a format selected from a first format and a second format, wherein the first format comprises a run field for storing a number of contiguous zero-valued bits beginning the index, a level field for storing bit values following the zero-valued bits in the index, and a length field for storing a number of bits in the sequence, and wherein the first element in the second format comprises an offset field for storing an offset value; and
if the first element is in the first format, then using information in the run, level, and length fields to retrieve a decoded symbol corresponding to the sequence of bits; and if the first element is in the second format, then using information in the offset field to locate a second lookup table.

2. The method of claim 1 further comprising:
accessing additional bits contiguous with the sequence of bits;
indexing a second element in the second lookup table using the additional bits, the second element having a format selected from the second format and a third format, wherein the third format comprises the run, level, and length fields; and
if the second element is in the third format, then using information in the run, level, and length fields to retrieve a decoded symbol corresponding to the sequence of bits and the additional bits; and if the second element is in the second format, then using information in the offset field to locate a third lookup table.

3. The method of claim 2 wherein the additional bits comprise exactly two bits.

4. The method of claim 2 wherein the first format further comprises an end-of-block marker but the third format does not include an end-of-block marker.

5. The method of claim 2 wherein the data is encoded using a compression format that uses Huffman tables for encoding and decoding, wherein the sizes of the run field and the level field in the third format depend on which Huffman table is used to encode the data.

6. The method of claim 1 wherein the first format and the second format each comprise a leaf bit, wherein the method further comprises examining the leaf bit to determine which of the first and second formats is used for the first element.

7. The method of claim 1 wherein the sequence of bits comprises exactly eight bits.

8. The method of claim 1 wherein the length field utilizes a length-plus-one format.

9. A computer-implemented method for decoding data, the method comprising:
forming an index comprising bits accessed from a data stream;
accessing an element in a first lookup table that corresponds to the index, the element comprising a bit value identifying the element as one of a terminating element and a non-terminating element;
if the element is a non-terminating element, selecting a second lookup table using an offset value in the element and repeating said forming and said accessing using the second lookup table instead of the first lookup table; and
if the element is a terminating element, retrieving a symbol using information in the element, wherein the information used to retrieve the symbol comprises a run field for storing a number of contiguous zero-valued bits beginning the index, a level field for storing bit values following the zero-valued bits in the index, and a length field for storing a number of bits in the index.

10. The method of claim 10 wherein the index for the first lookup table is formed from exactly eight bits accessed from the data stream.

11. The method of claim 10 wherein the index for the second lookup table includes exactly two bits.

12. The method of claim 10 wherein the element comprises a leaf bit, wherein the value of the leaf bit identifies the element as one of a terminating element and a non-terminating element.

13. The method of claim 10 wherein the data is encoded using a compression format that uses Huffman tables for encoding and decoding, wherein the sizes of the run field and the level field depend on which Huffman table is used to encode the data.

14. The method of claim 13 further comprising selecting a format for the terminating element depending on which of the Huffman tables was used to encode the data, wherein there are N different formats corresponding to N different Huffman tables.

15. A computer-implemented method for decoding data, the method comprising:
indexing a first element in a first lookup table using a first index determined from a sequence of bits in a data stream;
examining a leaf bit in the first element to identify the first element as one of a terminating element and a non-terminating element;
if the first element is a terminating element, then using information for the first element to retrieve a decoded symbol corresponding to the sequence of bits; and
if the first element is a non-terminating element, then accessing additional bits from the sequence of bits to determine a second index that is used to index a second lookup table that is located using information in the first element.

16. The method of claim 15 wherein the first element has a format selected from a first format and a second format, wherein the first format comprises a run field for storing a number of contiguous zero-valued bits beginning the index, a level field for storing bit values following the zero-valued bits in the first index, and a length field for storing a number of bits in the sequence, and wherein the first element in the second format comprises an offset field for storing an offset value; and wherein if the first element is in the first format, then information in the run, level, and length fields is used to retrieve a decoded symbol corresponding to the sequence of bits; and if the first element is in the second format, then information in the offset field to used to locate the second lookup table.

17. The method of claim 15 further comprising:
indexing a second element in the second lookup table using the additional bits, the second element having a format selected from the second format and a third format, wherein the third format comprises the run, level, and length fields; and
if the second element is in the third format, then using information in the run, level, and length fields to retrieve a decoded symbol corresponding to the sequence of bits and the additional bits; and if the second element is in the second format, then using information in the offset field to locate a third lookup table.

18. The method of claim 17 wherein the first format further comprises an end-of-block marker but the third format does not include an end-of-block marker.

19. The method of claim 17 wherein the data is encoded using a compression format that uses Huffman tables for encoding and decoding, and wherein the sizes of the run field and the level field in the third format depend on which Huffman table is used to encode the data.

20. The method of claim 15 wherein the sequence of bits comprises exactly eight bits and the additional bits comprise exactly two bits.
